(19) United States
(12) Patent Application Publication
(10) Pub. No.: US 2023/0362061 A1
(43) Pub. Date: Nov. 9, 2023

(54) NETWORK ELEMENT AND SERVICE DISCOVERY

(71) Applicant: Shabodi Corp., Toronto (CA)

(72) Inventors: Harpreet Geekee, Oakville (CA); Nitin Sood, Mississauga (CA)

(21) Appl. No.: 18/128,190

(22) Filed: Mar. 29, 2023

Related U.S. Application Data
(60) Provisional application No. 63/325,241, filed on Mar. 30, 2022.

(51) Int. Cl. H04L 41/12; H04L 41/16

(52) U.S. Cl. CPC H04L 41/12; H04L 41/16

(57) ABSTRACT

An Application Definition Function allows applications outside a managed network to transmit requests for configuration of the data plane of the managed network using a publicly accessible, and possibly trivialized API. The ADF resides within at least one of the management and control planes, and through a public interface receives the requests and makes use of both a discovered network topology and a discovered network service topology to generate a set of configuration requests that can be issued to nodes and functions within the managed network. The generation of the network topology and network service topology can be done through interrogation of network functions based on information in a repository such as a UDR. The ADF may provide these services for different networks such as a 3GPP compliant Core Network, a Radio Access Network, and an Edge network providing dynamic computing and communication resources.

### CROSS REFERENCE TO RELATED APPLICATIONS

This application claims the benefit of U.S. Provisional Application 63/325,241 filed 30 Mar. 2022; which is incorporated herein by reference in its entirety for all purposes.

### TECHNICAL FIELD

This application relates generally to a system and method for discovery of network elements in a mobile network that may include a core network, a Radio Access Network and Edge Network facilities, and more particularly to a system and method for discovery and characterization of network elements without the application requiring direct access or control of these network resources to allow for use of these network resources to enable services provided to a terminal device such as a user equipment.

### BACKGROUND

In third and fourth generation mobile networks, a core-network and evolved core network architectures were developed and standardized by the Third Generation Partnership Project (3GPP). This standardization defines the role played in by a number of different network elements (NEs). To allow for different manufacturers to provide their own implementations, the standardization defines both input commands and parameters that the network element will receive, and the output that the network element will provide. By defining only the external interfaces of an NE, standardization allows each manufacturer to create their own implementations which allows for optimization and customization to occur.

In a standards definition, a core set of features of an NE are referred to as mandatory features. To claim compliance with the standard, the NE must support these defined commands and parameters. Another set of features is defined as optional. If the NE is going to provide support for an optional feature, the feature must act on a defined command and set of arguments, but there is no requirement for an NE to support the feature. Some equipment manufacturers will provide an additional set of features that use commands and arguments that are proprietary. There is no need for these proprietary features to be disclosed or even standardized. In addition to the efficiency of operation, reliability and pricing, these proprietary features can often serve as a differentiator between NEs from competing companies.

### SUMMARY

With 5G standardization, the standardization of the network architecture is defined in 3GPP TS23. 501, starting with release 15, and continuing through releases 16 and 17. Procedures for functions defined in TS 23.501 are defined in TS 23.502, with some of the procedures being defined as mandatory, while others are defined as optional. It should also be understood that the interfaces over which these standardized functions communicate with each other are defined in TS 23.501. In some estimations, the standards essential features allow a network element to be sold, but the implementation of the optional features and Application Programming Interfaces (APIs) provide much of the value of the network function. But a set of proprietary features and APIs, along with the implementation efficiency and robustness, provide the market differentiation that allows an equipment vendor to secure a place in a network infrastructure deployment.

From the perspective of a network operator, knowledge of the network topology and the details about available hardware and software resources is important. However, for a number of reasons including security, this information is not typically shared outside the network. For a typical telecommunications core network there are effectively two ways to access the network: through the radio edge or through a packet gateway. A packet gateway will be understood in a 5G context as being a user plane function (UPF) designed to allow interaction between the core network and an external data network, such as the Internet. There are also mechanisms through which a device can connect to the core network functions without using 3GPP compliant access networks (e.g. connections that do not use the radio edge). Some such mechanisms rely on a Non-3GPP InterWorking Function which allows for access through connections designed for one or both of wired (e.g. cable or fiber) or wireless (e.g. WiFi) connections. While the above discussion centers around the data plane of a 5G core network (also referred to as the user plane), it should be understood that both a control plane and a management plane have been defined.

The abilities of the core network are partially dependent upon the User Plane Functions (UPFs) deployed, but the capability of the core network to manage traffic are typically reliant upon the management and control plane functions, and the features that they provide. Current standardized methods and procedures allow Application Functions (AFs) which reside within the core network to issue requests to management plane and control plane entities to configure connections to support the needs of the AF. Current standards do not provide a unified mechanism to provide such features to applications carried out on servers outside the managed network. Applications executed on application servers outside the managed network are treated differently than AFs within the network. Some network operators have developed proprietary interfaces for use with selected third party applications that may allow for some network support. The proprietary nature of these relationships requires that each application support a different set of interfaces for each network, and conversely may require each network provider to develop and support a number of different interfaces for each of the different external applications that are supported. In addition to the increased overhead of supporting these interfaces, the network operator needs explicit trust in the application provider because these interfaces may expose operational information about the network. AFs within the managed network can typically request Control Plane functions such as the Access Management Function (AMF) and the Session Management Function (SMF) to configure resources in the User Plane to handle traffic flows in a prescribed manner. This allows for the application of Quality of Service (QoS) on a flow by flow basis so that different types of traffic can be treated differently. As a result of network security concerns, among other issues, this ability is not extended to third party applications executed on servers outside the managed network (such as the core network).

When first conceived of and standardized, the Control Plane and its related functions were physical network entities (NEs) that provided defined functions. Network Functions were standardized with the notion that they were discrete hardware elements that used both general purpose and application specific hardware, to run software routines that enabled their functionality. As a result, the concept of maintaining a network topology to track deployed network functions and their supported commands and features was a relatively simple task. As network technologies advanced, the underlying technology used to implement network functions has changed. 5G standardization has taken into account the evolution of computing technologies, and has recognized the use of virtualization technologies. This allows for different network functions to be instantiated on a single computing platform in a manner that the function appears to outside entities as a standalone device. Virtualization techniques allow not only a rapid deployment of network functions, but also modifications to the computing and networking resources allocated to a given function.

Within a Packet Core Network, or an evolved Packet Core Network, virtualization has made it difficult to immediately identify the available network functions, their capacities and the resources that they consume. If a particular network function is created through virtualization, it may be registered within the network, but from a management perspective, it may still be difficult to determine the capacity of the network function as the resources allocated to a virtualized function can be increased or decreased without changing the outward appearance of the function. To a certain extent, this has been addressed in a 5G core network which is designed to be implemented using virtualization.

Within the 5G core network a Unified Data Repository (UDR) is employed to store information about the various network elements that are instantiated or deployed. As orchestration entities instantiate new network functions, or modify resource allocations associated with these network functions, the UDR can be updated to reflect changes in resource allocations. Additionally, the UDR can be used to track the manufacturer identification of the NF and the corresponding version number. In many deployments, the UDR is used as a data repository with access to the repository managed by a Unified Data Management (UDM) entity. In the following discussion, access to the UDR is described without explicit mention of the UDM. This should not be interpreted as not requiring the use of the UDM, but instead should be understood as allowing access to the UDR with or without use of the UDM.

However, one of the architectural designs of these core networks is that on the external side of a User Plane Function (UPF) acting as a gateway, the internal topology of the core network is opaque to external entities including Application Servers supporting applications access by users through the core network As such, while applications inside a core network can access information about a network configuration, and thus issue requests to at least one of management plane entities and control plane entities for QoS rules and data flow routing to be adjusted for data flows matching certain characteristics, applications outside the core network will not be able to see the individual network functions, and the corresponding connections between them, let alone specific information including the version of the network function, or the resources allocated to the function.

Without the ability to perform its own network discovery procedure within the core network, an application outside the core network is at a decided disadvantage in comparison to application functions residing within the core network, as the external applications do not have the ability to interact with control and management plane entities which can configure network connections to suit the needs and requirements of the application. Developers of applications outside the core network are required to design a plurality of different versions of their applications suited to the different networks that operators provide. Rudimentary information about a core network may be provided to an application outside the core network if there is a predetermined relationship between the application and network providers. Typically, this sort of relationship is only available to the largest of external service providers, and the nature of the interface often varies between different carrier and service provider pairings. A network discovery procedure that can be executed without the intervention of or specific pairings with a network operator would allow for a system in which applications outside the core network can request configuration for data flows in a manner that can be acted upon by a core network at the management plane or control plane.

It would therefore be beneficial to have a mechanism that allowed for both discovery of network elements and characterization of the discovered elements.

It is an object of the aspects of the present invention to obviate or mitigate the problems discussed above.

### BRIEF DESCRIPTION OF THE DRAWINGS

Embodiments of the present invention will now be described in further detail by way of example only with reference to the accompanying figure in which:

FIG. 1 is a functional illustration of an Application Definition Function interacting with application through a public API to provide access to the functionality of network elements;

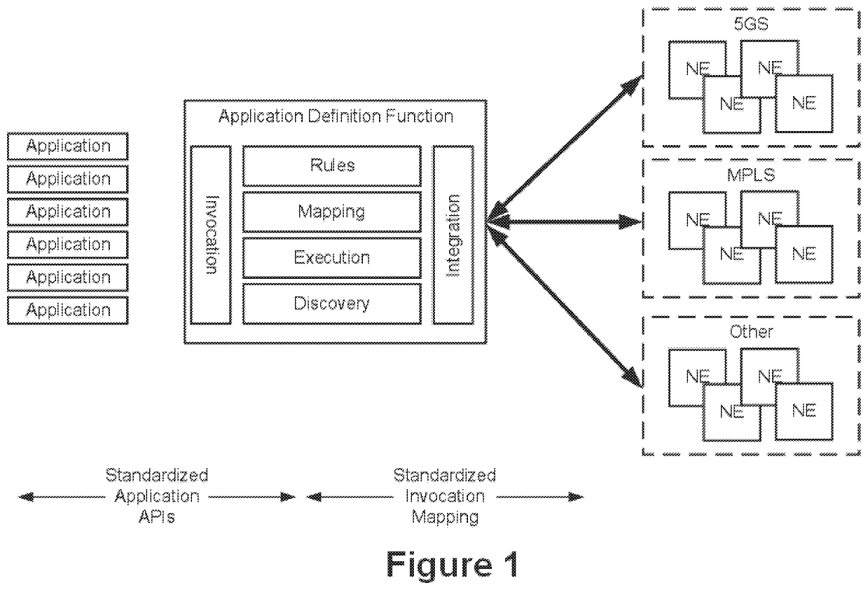

FIG. 2 is a block diagram illustrating an application outside a wireless network establishing connection parameters within the wireless network through services provided by the Application Definition Function;

FIG. 3 is a flowchart illustrating a method of network element discovery and characterization;

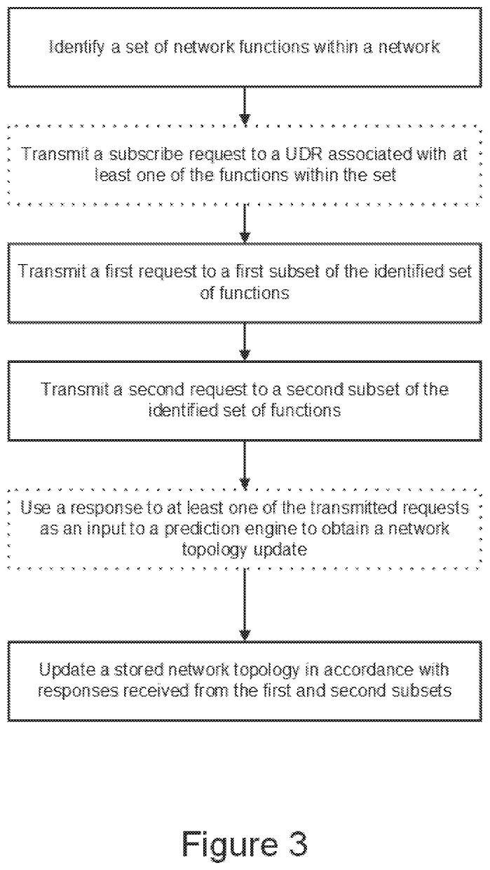

FIG. 4 is a flow chart illustrating a method of admitting a connection request carried out by an ADF;

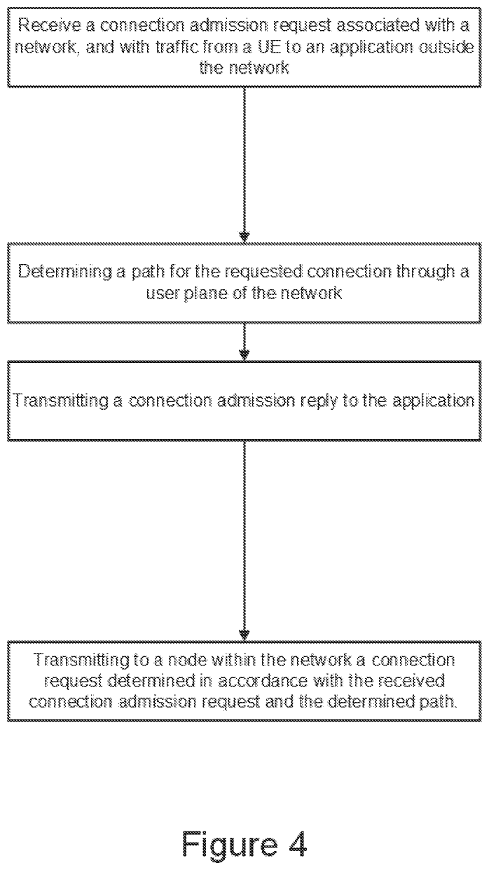

FIG. 5 is a flow chart illustrating an embodiment of a method of connection request management;

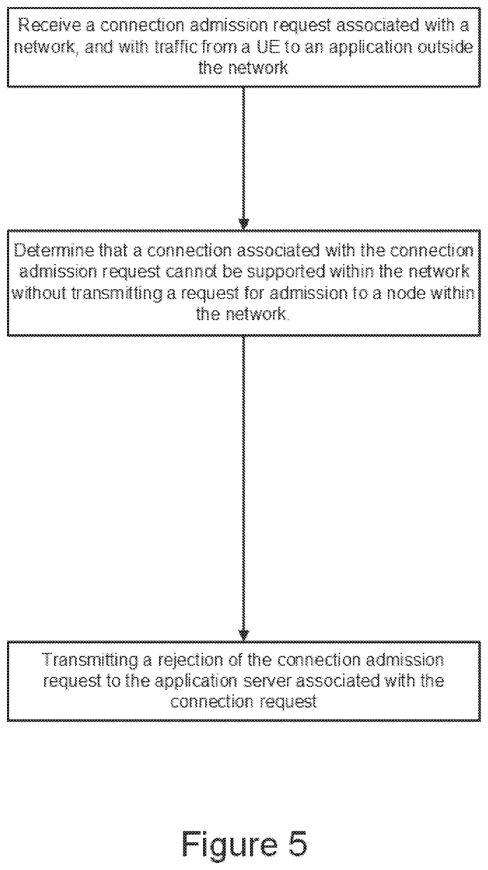

FIG. 6 is a block diagram illustrating an example platform on which an ADF can be implemented;

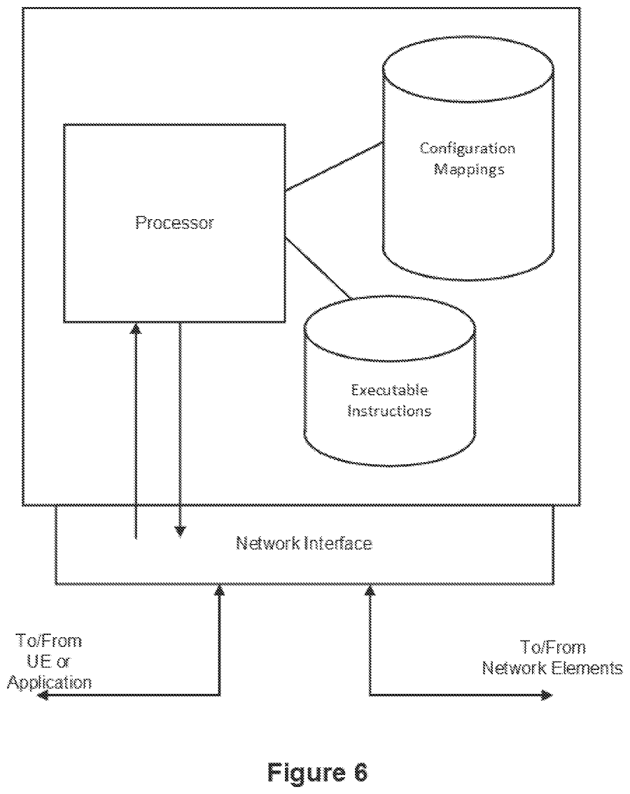

FIG. 7 is a block diagram illustrating the interaction of components outside a 5g NRAN with NEs within the NRAN via an ADF; and

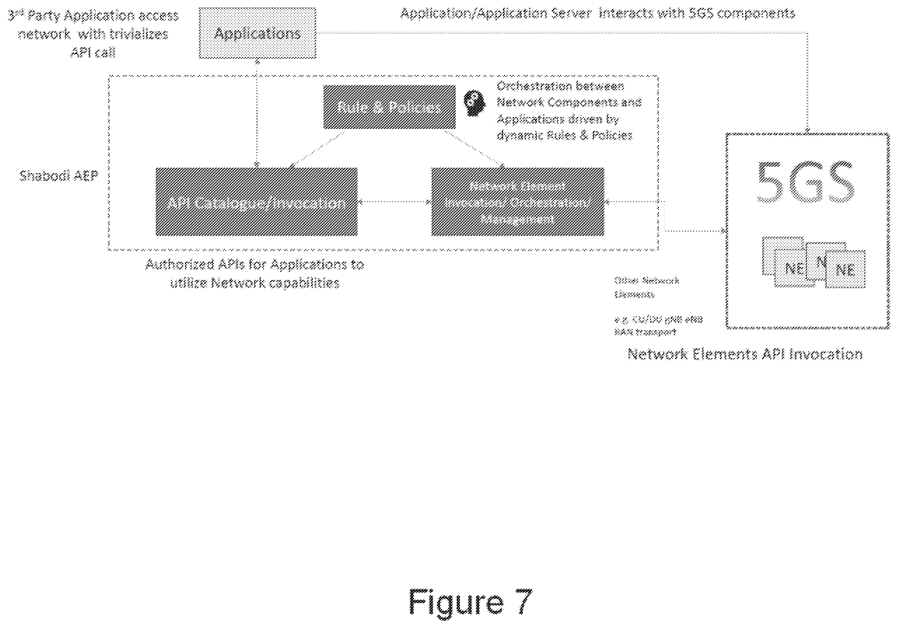

FIG. 8 is a block diagram illustrating the simplification of interactions between Applications outside a network and network elements from a variety of different equipment vendors inside the network.

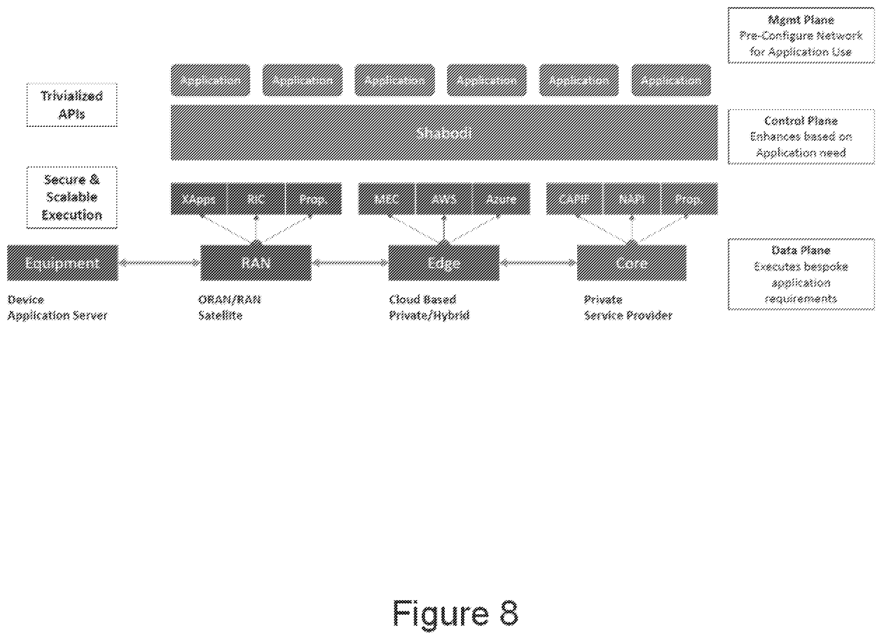

Where possible, in the above figures, like reference numerals have been used for like elements across the figures.

### DETAILED DESCRIPTION

In the instant description, and in the accompanying figures, reference to dimensions may be made. These dimensions are provided for the enablement of a single embodiment and should not be considered to be limiting or essential.

In a co-pending application (filed on Aug. 11, 2021, accorded U.S. Provisional Patent Application Ser. No. 63/231,837, and incorporated herein by reference), an Application Definition Function (ADF) is disclosed that allows applications outside the core network to transmit requests in a defined format to the ADF. The ADF acts as an interface between an application outside the core network and both management and control plane functions. Where typically, applications outside a core network are not able to request connection configurations for data flow through the core network, the ADF has visibility into the otherwise opaque network, and can make connection configuration requests on behalf of the application. The ADF is able to make use of knowledge of the network elements, the configuration of the network elements and the topology of the network that includes these network elements to configure a suitable path for data to transit through the network. This can be used to allow an application outside the carrier to request a configuration for a connection serving traffic between a user equipment (UE) connected to a Radio Access Network (RAN) to an Application Server outside the core network associated with the RAN. In this way, a connection between a UE and an Application can be configured with a Quality of Service in the segment of the connection that runs through the core network, and possibly through the RAN. This is distinct from the conventional network configuration where outside applications do not have access to a proxy that allows for network configuration requests to be received, let alone acted upon. The ADF may have access to some network topology information through core network elements such as an NF Repository Function (NRF). However, as will be discussed below, the information that can be relied upon to be available within an NRF is limited in scope, and may not be sufficient for the ADF to provide an optimized response. Thus, the ADF will make use of NF interrogation to build an enhanced and accurate network topology. Thus, the ADF can both perform network element discovery, and undertake a network element characterization process to determine the commands and functions available at a given network element.

This information can be used by the ADF in determining how connections can be routed, and how to set up the connection at each network element, based on both the functions supported at different network functions, and network conditions (or using modeling of expected network conditions). Using this enhanced network topology, the ADF, upon receipt of a connection configuration request from an application can select the network elements that make up the routing, and can configure the network elements accordingly. This provides functionality to applications outside the network that would normally be reserved for applications inside the network. The ADF acts using a knowledge of the core network topology to translate the application request into a set of requirements that make use of the functions and topology of the core network. This set of requirements can then form the foundation of a set of requests sent by the ADF to a variety of (typically) Control Plane functions to set up or modify connections between nodes connected to the network. In the following discussion examples will be provided using different types of network through which this functionality can be provided, including wireless core networks, Radio Access Networks, Edge Computing Networks, and backhaul networks. It should be understood that the ADF can provide a single standardized interface to applications that both hides the complexity of the network from the application, and protects the network elements from access by unauthorized applications. While this simplifies the design of applications for application developers, it requires that the ADF have knowledge of the topology of the core network. The ADF can appear to the other elements within the carrier network as a control or management plane entity, while presenting itself to outside applications as a proxy that provides a simplified interface through which requests for network configuration can be made. These requests can use an interface that allows the application to be agnostic to the carrier network design, and may involve the use of an interface that uses generalized or trivialized parameters. These parameters, optionally in conjunction with knowledge of the requesting application, can be used by the ADF to generate complex network configuration requests sent to different network nodes or functions to configure a path for a data flow.

Part of this can be achieved by allowing the ADF to subscribe to updates from the UDR associated with network functions. This may entail a subscription to updates from a UDM that accesses the UDR. The UDM is designed to allow network functions and nodes to subscribe for updates in data stored in the UDR, allowing changes in characteristics that are stored in the UDR to be pushed to the functions within the network. The ADF, by acting as at least one of a network function and an application function within the core network is able to receive notifications associated with changes such as the installation of software updates to a network element. This does not however necessarily allow the ADF to determine when new network functions are added to the network, nor does it necessarily allow the ADF to access an initial topology for the core network. Thus, a discussion of the overall network discovery procedure, along with the objectives of the discovery procedure will be addressed. The ADF can also act as a carrier network application function, serving as a proxy for the application server outside the network. While acting as an application function, the ADF can modify configuration parameters or session parameters as if it were the application. This provides the external application a level of configuration and session management control that would otherwise not be available.

A network topology of the available network elements/network functions, that simply indicates the presence of a NF and its location or connectivity in the network is not necessarily sufficient. As noted above, an NF will support a mandatory set of features, and it may support an optional set of features. Both mandatory and optional features and the syntax and arguments used when calling them are typically defined by standards. Optional features may provide functionality or information that are not easily obtained using only mandatory features, but as indicated by their name, support for optional features is not universal. So, it is important to be able to characterize a network function by not only topographic information, but also in a way that indicates which features are supported. If it can be determined that an identified network function supports optional features, and which subset of the set of defined optional standardized features are implemented. This can allow the ADF to more robustly use the available resources in the network. Typically a network function can be identified by an indication of the manufacturer and the network function. For example, an SMF may be identified by both a code indicating the manufacturer and a code indicating that it is an SMF. The combination of these codes can be assumed to be unique. In addition to this, other identifying information may include a software version in addition to a firmware version.

In some embodiments, the ADF resides within the control plane of the target network. In other embodiments the ADF may be implemented as a management plane entity, or within an operations support system and business support system (OSS/BSS) subsystem. This ability to be a part of the management and/or control planes allows the ADF to configure the manner in which application traffic is handled and/or processed within the network. Thus, the ADF can interact with at least one of management plane and control plane entities to influence and control data plane (or transport plane) entities and their configurations. In some embodiments the operator may elect to configure the ADF with a provided topology indicating the presence of various network functions within the network. This may not always be the case, as it requires the network operator to undertake a characterization of the network, to enable a network function that is supposed to simplify operation for others. Relying on the network operator to provide a topology for use by the ADF may present an obstacle to implementation, as it increases the work required of the network operator. Instead, in some embodiments, the ADF can undertake a network discovery process without necessarily relying upon operator pre-configuration.

Network discovery, in the context of the ADF, may allow for a network discovery that is limited to particular sets of network elements and the connections between them instead of being a fully network wide process. In one example of network discovery being performed in a limited set of network elements, the ADF may exclude certain types of network functions from the topology it builds if these network functions are excluded from access to external applications by the network operator. Where an ADF does not need to interact with, or is intentionally excluded from interacting with a particular type of NF, either in the data plane or the control plane, these NFs can be omitted from the ADF-centric network topology built by the discovery process. In one example, if the ADF does not interact with network functions, such as those associated with a public warning system, the discovery algorithm can be considered complete even if it has not fully discovered nodes associated with the public warning system.

As noted above, building a topology of the network, either through network discovery procedures or through operator configuration generally omits information that is of little interest to most systems, but may be of importance to the ADF. Thus, the ADF is not limited to a network discovery process, and may undertake a process of network service discovery, where the ADF determines the network functions within the network, as well as the services provided by each function, and by combinations of different functions. This network service discovery makes use of the characterization of functions to identify the features and services that are available through each network function. When a NF is detected, simply knowing that it is a particular network function provided by a particular manufacturer is sufficient to know that the NF will support the mandatory features of the standard. This does not indicate which (if any) of the optional features are implemented, or whether there are proprietary features supported.

Upon discovery of an NF within the core network, the NF can be interrogated by the ADF in the form of requests transmitted to the NF in the form of requests for standardized, but optional features. The NF will respond to the requests, and this will provide an indication of whether a given optional feature is supported by the NF. Within a single core network, there may be a plurality of types of NF (e.g. there may be a plurality of AMFs). If each of the NFs of a single type are provided by the same manufacturer, it may be possible to interrogate only a subset of them to determine if they support a particular subset of optional features. It should also be understood that if there are a number of NFs of a given type, each of these NFs may be interrogated to see if it supports a different subset of the optional features. This can provide an indication of which features are supported by NFs in the network, and possibly in different geographic segments of the network. It should be understood that each NF can be identified by a number of features, including any of a manufacturer identifier, a type identifier (e.g. an identification that it is a particular function, such as an AMF), a software version identifier, a firmware version identifier, and an identifier of a hardware platform upon which the software is run. In some networks, it may be desirable to characterize each instance of an NF independently of any similar NF. The identification information recited above may indicate a set of optional and proprietary features that may be supported by the NF, but only through exhaustive interrogation can each individual NF be properly characterized. This characterization of the NF allows for a determination of the services exposed by the NF over different interfaces or sets of interfaces.

Because there may be a variation in the subset of optional features that are supported, the results of these interrogations may be used as an input to an Artificial Intelligence/Machine Learning prediction engine that makes use of the input to provide a prediction of the features supported by different NFs in the network. It should be understood that in some networks, the results from interrogating a first type of NF may be predictive of the features supported by other types of NF. Furthermore, there may be geographic dependencies, where NFs of a given type in one geographic segment of the network supporting a set of optional features is predictive of NFs of that type but in a different geographic segment not supporting the optional features based on a difference in the NF manufacturer.

These complex relationships between types of NF, the geographic location of the NF within the network, the manufacturer of the NF, the version of the software, and other such features is something that may not be apparent to a human being looking at the network without an understanding of the network planning and design. The use of an AI/ML prediction engine allows for the predictions to make use of cross-related information that may not be apparent at first glance.

In some embodiments, any AI/ML prediction of the supported features may be verified post characterization to ensure that each NF is properly characterized. This may be advantageous during an initial characterization cycle.

When the ADF has a profile for an NF, it can subscribe with the UDR, for alerts associated with the NF. For example, the ADF may subscribe to receive alerts about changes in the software version associated with each of the NFs of a given type. An update in the software of an NF, to a version supported by other NFs supporting a different set of optional features, may be predictive of a change in the set of optional features supported by the NF. For example, if NFs in the core network from a particular vendor all support a first set of optional features at version 1, and all support a second set of optional features at version 1.5, when an NF is upgraded from version 1 to 1.5 the ADF will receive an alert from the ADR that the software version has been updated, and the predictive engine can update the predicted feature set to include the optional features associated with version 1.5. As noted earlier, this characterization may be finalized over a period of time to avoid taxing any of the ADF, the NF and the connectivity resources of the network. During operation, the ADF may make requests of a particular NF based on a predictive model, and based on the responses to these requests can modify the model of the NF. This may also result in a change in the predictive modeling as well.

The use of a predictive engine also reduces the number of interrogation based requests that the ADF has to send at a given time, and thus the number of replies that it needs to process.

Additionally, the ADF can use this distributed interrogation to reduce signaling storms within the network. To further reduce the signaling, it is possible for the ADF to only verify that a particular NF supports optional features when there is a need to send a request for an optional or proprietary feature to the NF. The ADF, knowing that this feature support is only predictive and can have a planned fall back if the optional feature is not supported. If the optional features are not supported, the ADR generated network topology can be updated, and a fall back path can be used, such as the use of a different NF that supports the optional features, or the request sent to the NF can be reformulated to use only features that the NF does support.

Thus, by using a network discovery algorithm, the ADF can determine which network functions are available in the network. Through communication with the UDR and with the NF itself, the ADF can select a model for the NF that includes the mandatory features, and a predicted set of optional features that the NF in question will support. This information can then be used to select the NFs with which to communicate when the ADF receives a request from (or on behalf of) an application.

It should be understood that the discovery and characterization of NFs in the network is a dynamic process. NFs can be added to and removed from the network. When an NF is discovered, the ADF can subscribe for updates associated with that NF with the UDR. This not only allows the ADF to be notified of the NF receiving a software update, but it can also allow the ADF to be notified of the NF being decommissioned and removed from the network.

The querying of the UDR, will typically provide an indication of an NF type, the manufacturer and both software and firmware versions. In some implementations, the UDR will not provide a model number or equivalent information. This can be obtained through interrogation of the NF. The ADF can use a model number and manufacturer identification (and in some cases the software and/or firmware versions) to determine the possible set of proprietary features that could be supported by the NF. Because, much like optional features, proprietary features do not need to be supported, they are used by manufacturers as differentiators over competitor products. In some networks, optional and proprietary features may be enabled on NFs without the knowledge of the network operator, leaving this characterization process as the only available method to determine the features that can be invoked by the ADF. These features may provide information about the NF itself, including loading information, available resources, etc., or they may allow for different configurations to be supported. Where standardized optional features have a defined request name and format, proprietary features may have request names that vary between products, let alone across manufacturers. As such, it should be understood that two NFs of the same type from the same manufacturer, may have different names and arguments for requesting proprietary features that do the same or similar things. As such, the ADF can access an internally maintained, or access an externally maintained, resource that lists the proprietary features supported by different NFs of a variety of different types for different manufacturers. For a single NF model by a particular manufacturer, there may be different sets of proprietary features supported across different software versions. After determining the possible set of proprietary features supported by an NF (or a group of the same model of NF) in a network, the proprietary features supported can be predicted based on the analysis of responses to requests sent to the NFs by the ADF. While this is similar in nature to how the support for optional features is performed, it should be understood that determining the set of possible supported proprietary features differs as it requires identification of the model of the NF instead of just its type. This allows for differentiation of two different NFs of the same type offered by a single manufacturer (e.g. a standard and deluxe version of an AMF could be offered, with different characteristics and possibly different sets of proprietary features that are accessed using different requests with different parameters).

As noted with respect to the standardized optional commands, the ADF can use the predictive engine to identify a likely set of supported features, and then revise or confirm this list of supported features over time.

The ML-based predictive engine can help in building a topology of the network that allows the ADF to select which of a number of different NFs should be selected when a request is received from an application. The receipt of a request from the application is followed by a selection of the NFs within the network to use to serve the application request. The NFs can be selected on the basis of their characteristics (both predicted and verified). This selection of NFs can take into account information received from the NFs about loading, capacity and which set of features is supported. The ADF can then generate a set of requests to be sent to each of the selected NFs. The models of the selected NFs in the generated topology can be updated based on responses received from the NFs as a result of transmitting at least one of the generated requests. The model of the NF is also updated in response to information obtained from the UDR indicating a change in the NF.

With the dynamic updates to the models of the NF within the generated topology, it is also possible for the ADF to predict the response that will be received from an NF to a generated request. This may allow the ADF to receive a request from an application, generate a set of requests for NFs within the network in accordance with the received request and the dynamic topology model, transmit a response to the received request to the application, transmit at least a portion of the generated requests to the selected NFs and then receive a response from the NFs. This may allow the ADF to provide a lower latency to request processing as the responses to a plurality of different requests to a set of NFs may create a higher latency than desired.

It should be noted that by providing a response to the application before receiving a response from the NFs may involve the possibility that at least one NF rejects the request. In such a situation, the ADF can select a different set of requests for a different set of NFs, and then send that set of requests. In other embodiments, the transmission of a response to the application can occur after the transmission of requests to the NFs, but before receiving all the responses from the NFs. The predictive engine can be used to anticipate rejections of requests based on the time it takes to reply, and the replies received from other NFs.

Although in the above description, there is explicit description of building a topology of the core network, it should be noted that one of the core network elements is the base station, referred to as a NodeB, eNodeB or gNodeB in different standards. The topology of the RAN may be obtained through communication with the base station, which may have a number of different components. In some embodiments, the base station will be a distributed system making use of a central unit (CU) and one or more distributed units (DU). Through communication with a gNodeB, the topology of the RAN associated with the particular gNodeB may be obtained. Similarly, the gNodeB is able to provide an indication of the temporary RAN resources including User Equipment nodes acting as repeaters and forwarding units (supporting one or both of in and out of band communications). The same interrogation techniques discussed above along with the AI/ML prediction engine can be used in the RAN aspects of the network with modifications to make them specific to the RAN instead of the core network.

The dynamic discovery and characterization process making use of a prediction engine (which may be based on AI/ML) may be required because although the ADF may be treated as a function within the management or control planes, the ADF is not necessarily a function that is fully operated by the network operator. The ADF allows external applications to transmit requests for resource allocations into a mobile network, without knowing the structure of the network. The mobile network may be dynamic in nature, not just in terms of traffic flows, but also in terms of the network functions present within the network, and the features supported by the network functions. The mobile network is a complex and dynamic network, the complexity and dynamism of which is hidden from the applications both to simplify the development of applications and to protect the security of the mobile network. The discovery and characterization process outlined above allows for the ADF to have a model of the network that includes an indication of the capability of each of the NFs within the network. This allows the ADF to select NFs based on their suitability to serve the application requirements, the features provided, their location both topologically within the network and geographically, and an anticipated loading and demand for the NFs.

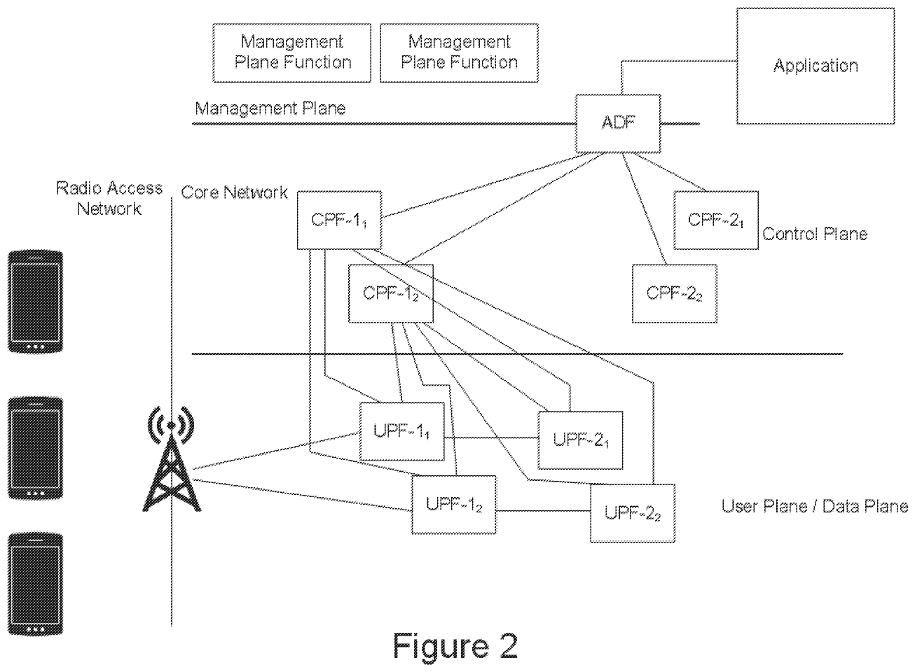

As noted above, AI/ML can be used in the network discovery process. However, it should also be understood that AI/ML techniques can also be used after the network discovery has been performed, and during operation of the ADF to support application requests. In a network with a variety of different network functions in either of the Control Plane and User Plane, selecting a path through which user plane traffic is routed is important for ensuring QoS is maintained. As can be seen in FIG. 2, the ADF can be thought of as either of a Management Plane Function or a Control Plane Function as in some embodiments it may operate like either one. It has an interface to an external application, through which the Application can provide information about the levels of service that connections that the UE needs to the application to provide proper access.

In the illustration of FIG. 2, the ADF receives a request to establish a user plane connection for a designated UE associated with the application. In some embodiments, the ADF can transmit a response to the admission request to the application without necessarily knowing the exact routing of the traffic between the UE and the application through User Plane Functions. This advance admission of the connection can be performed using knowledge of various network statuses and load levels. This information may be stored by the ADF based on information obtained from different admission requests and historical use information. This stored information can be used as input to create an AI/ML model that allows the ADF to pre-determine which network routing patterns should be used. Furthermore, with reference to FIG. 2 there are two illustrated paths for UE traffic to the application: through UPF-11 and UPF-21 or through UPF-12 and UPF-22. Based on a model of network behavior an AI/ML based path routing engine can determine which pathway through the network is most likely to be able to support the connection request. It should be understood that although illustrated here at two paths of two nodes, in most network implementations there would also be connections between UPF-11 and UPF-22 and between UPF-12 and UPF-21. Thus, as the number of UPFs that can be used for different functions increases, the number of possible routes can also increase exponentially. By being able to use predictions about network behavior, the ADF can determine that there are specific routes available, which can allow a faster response to the connection admission request from the Application Server. Those skilled in the art will appreciate that almost as much value may be derived from the ability of the ADF to use this model to allow for a pre-emptive rejection of the connection request. This rejection can be issued without necessarily making a request of the CPFs, which will result in a faster response to the Application Server.

By being able to offer predictive acceptance and rejection of connection requests, the ADF allows the Application more time to be able to allocate resources to the user connection. Furthermore, if the admission of a connection is rejected, the ADF and the Application can enter a negotiation process to determine whether an alternate connection request can be supported. If the Application can provide an acceptable service to the end user through a differently configured connection, the Application and ADF can engage in that negotiation without involving the connection admission resources in the network. In a 5G core network, admission control may involve control plane functions such as the Access & Mobility Management Function (AMF) and the Session Management Function (SMF). In the above scenario, the ADF may suggest connections that can be supported to the Application. This negotiation process can be undertaken with the ADF making use of the AI/ML engine and the models of the network behavior under load based on historical activity. When the ADF has determined that there is a connection suitable for the Application and most likely supportable by the network, a request can be made of CPFs. This reduces much of the interactions with these CPFs during heavy loading, which is a time during which they are least able to support the back-and-forth of an admission negotiation.

After the Application and ADF have determined a path that can connect the application to a UE attached to the network, the ADF can transmit the request for admission of a connection using the determined path. With a good model for use by the AI/ML engine, using information that the ADF can obtain, the connection request may be more likely to be accepted in the network.

As can be seen from FIG. 2, one of the first decisions that may be required by the ADF is which control plane functions to engage with for various admission control functions, or for various modifications to existing connections. The ADF may be privy to CPF and UPF loading information in some embodiments, or it may only have historical information. The loading information may be explicitly determined or it may be determined through the use of looking at response times from various CPFs and UPFs. For example, if there are two AMFs and two SMFs in the control plane that each serve an overlapping set of network segments, the ADF may issue a request to a first AMF, and based on the reply time may determine that the selected ADF is heavily loaded. A subsequent request may be sent to the second AMF. Similar processes may take place to determine loading of other nodes in the network.

In some networks there may be redundant connections between two different network functions. The CPFs may use a round robin allocation to manage traffic between the two nodes. This may result in the two nodes having sufficient computation resources to manage a connection, but the connectivity resources between the nodes may only support the connection on one of the two paths. The ADF may have insight into this if it happens on a regular basis based on an analysis of the historical loading information. With this knowledge available, the ADF can select a connection routing that may otherwise be rejected due to the specification of connectivity resources.

In some network configurations, different sets of CPFs may be responsible for different sets of UPFs in the same geographic area. This allows a UE to connect to a gNB, and have the gNB select the CPFs through which the UE connections are managed. The ADF may be able to identify routes using different UP resources than would otherwise be available to the UE. In such a case, the ADF may transmit a request for a CPF to have the UE re-establish a network connection with an instruction to connect to a different set of CPFs. This can be done so that the ADF can select a different set of UP resources than would otherwise be available, which may allow for the ADF to provide a connection that would otherwise be rejected.

In the above description, the ADF has been described as an entity that can reside within either the management plane or control plane of a core network to allow external applications to transmit requests for QoS and other network services to a simplified API. The ADF hides the complexity of the network from applications so that no application needs to know the details of the network topology. The flip side of this is that the network does not need to trust any application with access to operational details. Instead the network recognises the ADF as a trusted entity, and relies upon the ADF to validate the applications making requests. As described above, the ADF can make use of resources within the network along with machine learning, to characterize the available network elements and to predictively select network elements to include in a path configuration request for an application. It should be understood that the ADF can also serve a similar purpose in the Radio Access Network (RAN).

Many 5G RANs make use of distributed processing and data centers to instantiate virtual entities within the RAN topology. For example, while a set of antennae cannot typically be virtualized, the use of a Central-Unit (CU) Distributed-Unit (DU) split can allow for the instantiation of a virtualized entity (a DU) topologically close to the radio unit containing the antennae, so that processing of Radio Link Control (RLC) and Media Access Control (MAC) and some parts of the Physical layer (PHY) can be performed in real-time. The DU then performs RRC and PDCP functions. One DU may interact with a plurality of difference CUs, with each CU-DU pairing having the ability to appear as a gNodeB in the network.

This change in the standardization of the RAN allows for the RAN to make use of edge computing resources to implement the networking features expected within the RAN. This allows for the allocation of resources to vary to accommodate changes in resource demands associated with variable traffic. However, this process is typically reactionary, but could be done proactively when the network is aware of an upcoming change in traffic demands.

The presence of an ADF within a control plane for a RAN, or within the control plane of an associated core network, but with visibility into RAN resources, can allow for applications to make requests for the allocation of resources within both the core and the RAN. An ADF having the ability to interact with RAN resources can also be used to prevent trial and error based requests being transmitted into the RAN from both core network elements and from applications. An ADF residing within the RAN control plane, and accessible to applications outside the RAN (which may include applications and application functions within a core network as well as outside the carrier network) is able to act as a proxy for RAN configuration requests. Much like its deployment as a proxy within a core network, a RAN deployed ADF receives requests from outside the RAN. The ADF can monitor the source of requests, and the frequency with which these requests are received. To avoid an excessive signaling storm caused by an application transmitting a large number of configuration requests in series (which may be done in an attempt to obtain one of a desired number of data path configurations), the ADF can aggregate configuration requests, filter configuration requests, or simply drop configuration requests. The ADF can, in a proxy-type role, act on behalf of both the application and the network within which it resides. Thus, to protect the resources within the RAN, the ADF can receive configuration requests, and determine how they are handled in accordance with many factors including the number of configuration requests it receives from the same application. This can allow the ADF to protect RAN resources from aberrant behavior of external applications. By performing a similar process as the network discovery and network service discovery outlined above with respect to the core network a RAN-based ADF can model the traffic within the RAN and the impact of this traffic on the availability of network functions and the services they provide. Thus, upon receiving a request for configuration of a radio access channel to a UE, the ADF can determine how best to satisfy the request, including through offering different service levels if the requested configuration cannot be provided. This negotiation, which may be done with an application, an ADF within a core network, or another such network entity, can be done without transmitting requests to RAN nodes to mitigate configuration signaling within the RAN.

As with the core network, it should be understood that all vendors should be supporting the mandatory features defined in 3GPP standards. Some units will support optional features, with the support determined on an element by element basis. Another set of network elements will support a set of proprietary features, much as they did in the core network. A combination of the hardware platform, software version and other such parameters can allow the ADF to determine the total set of possible features supported by an element. Interrogation of the network element, either during low traffic times or in a path configuration process can allow the ADF to determine the specific set of features supported by a given RAN network element. It should be understood that these features may not only include different procedures that can be implemented, but may also include physical features including the ability to transmit using different waveforms, or to transmit in different frequency bands.

By building a catalog of the features supported by a given network element, and then updating the catalog with each update to the network element (and possibly with the migration of the network element to a different platform within the RAN or within an edge computing resource used by the RAN), the ADF is able to build a model of the resources available to applications making requests for allocation of resources between the UE and the application. It should be understood that in the context of a mobile application, typically the application server will be topologically stable, but the UE that connects to the application can move from one connection point to another (e.g. move from a first gNodeB to a second gNodeB). These changes in connection point may be the result of a geographically mobile UE, or a dynamically variable RAN topology that may cause a UE to move to a different connection point regardless of UE mobility. It should be understood that some of the features described above may be dependent upon the ability to make use of real time data. In some embodiments, time delayed data in place of real time data may be employed with corresponding changes to the manner in which predictions are employed.

To reduce the effects of this movement of the UE with respect to the RAN topology, an ADF may request resource allocations that are not immediately ideal for the UE-to-Application path, but that may provide a more consistently stable connection. Similarly, resource allocation requests may be made to create a set of connection points to which the UE can connect that ensure that the connections are supported in a frequency band that provides both the throughput and stability required by the application. The ADF may enter into a negotiation with the application for a suitable set of resources, without reserving the resources within the network based on a number of factors (including both a prediction of available static resources such as frequency bands available, and based on the ability of an associated edge network to expand the resources that can be allocated to the operation of RAN elements).

As with the RAN and Core networks, it is also envisaged that the ADF can interact either directly or indirectly with the resource allocations within an edge network associated with any of the RAN, the Core Network and the application. Where RAN or Core Network (CN) resources instantiated upon computing storage and memory resources of an Edge Network (EN), the ADF may be provided access to functions such as network orchestration entities within the respective networks, or may otherwise access EN resources through an API, such as the API used by the RAN or CN to interact with the control entities within the EN.

Using the same dynamic as with the RAN and CN, the ADF can be provided an indication of the available resources, and the resources allocated to any of the instantiated entities. Information about the resources available and allocated may be accompanied with an indication of a geographic location in which the resources are available. When the application requires resources within an EN, the location in which the necessary resources are available can be taken into account so that the application can be provided resources that are at least one of closest to the UE, closest to the UE with a minimum of resource migration along an expected UE mobility path, closest to the resources allocated to one of the CU and the DU through which a UE is connected. Other factors may include the utilization of resources within the EN, utilization of a particular type of resource within the EN, congestion of connections between different ENs and nodes within the CN, congestion within the EN, reachability of the EN from a current physical or a current topological location of the UE or other such resource It will be apparent to those skilled in the art that in some situations, the optimal placement for resources within the EN may be at a datacenter not used by any of the RAN resources, but instead at a data center that is equally distant (geographically or topologically).

In some networks, a variety of different EN service providers may be used. For example, some networks may make use of EN resources from a publicly available third part, such as Amazon Web Services, while others will use private EN providers. Some RAN and CN resources will be supported by EN resources in networks owned and managed by the network operator. A common API may be provided across the RAN, CN and EN resources, such as the 3GPP Common API Framework (CAPIF) or other such interfaces both public and private. Those skilled in the art will appreciate that other APIs specific to the different portions of the carrier networks and affiliated resources may be supported where necessary.

With an ADF that can interact with the RAN, CN and EN, an application can make a request for a connection between the application server and an UE, and have each segment of the network managed and configured appropriately. Where the Application Server uses distributed computing resources, it may be possible for traffic to be routed from the RAN, into an EN resource (such as a local instantiation of an Application Server) and from the mobile network EN to connect to the distributed resources of a central instantiation of the Application Server. Where the EN and the Application Server make use of a common service provider, it may be possible to route connections from the UE to the Application Server that otherwise bypass parts of the mobile network.

As noted above, connections between nodes and functions in the drawings are done for the sake of simplicity of explanation. The size of a connecting line should not be interpreted as being directly associated with a bandwidth or other such characteristic of the connection. Where functions are shown as being connected, direct connection is not necessarily intended, and instead a logical ability of the nodes or functions to connect to each other should be understood. The sizes of nodes in the drawings are provided for exemplary purposes and should not be considered to be indicative of resource allocation. The configurations illustrated in the drawings should not be considered as limiting of the scope of the invention, which is defined solely in the claims.

1. A method, comprising:
identifying a set of network functions of a network function type within a network;
identifying a first set of functions associated with an application that communicates via the network;
identifying a second set of functions associated with the application;
determining a first subset of the identified set of network functions based on a correlation between the first set of functions and the set of network functions;
determining a second subset of the identified set of network functions based on a correlation between the second set of functions and the set of network functions;
transmitting a first request to the network, wherein the first requests queries the network regarding the first subset of the identified set of network functions, the first request determined in accordance with a predetermined set of optional features associated with the network function type;
transmitting a second request to the network, wherein the second request queries the network regarding the second subset of the identified set of network functions, the second request determined in accordance with a predetermined set of proprietary features associated with the network function, the network function type and a manufacturer of the network function; and
updating a network topology in accordance with responses received from the network to both the first request regarding the first subset of network functions and the second request regarding the second subset of network functions.

2. The method of claim 1, further comprising:
transmitting a subscribe request to a Unified Data Repository within the network, the subscribe request associated with at least one of the identified set of network functions.

3. The method of claim 2, further comprising, updating the network topology in accordance with a response to the subscribe request indicating a change to at least one of the identified set of network functions.

4. The method of claim 2, wherein the identified set of network functions resides within one of a Radio Access Network, an Edge Network, and a Core Network.

5. The method of claim, 1 further comprising:
using at least one received response to the first request as a first input to a prediction engine;
using at least one received response to the second request as a second input to the prediction engine; and
wherein updating the network topology comprises updating the network topology in accordance with an output from the prediction engine.

6. The method of claim 5, wherein the prediction engine makes use of machine learning algorithms.

7. The method of claim 6, wherein the machine learning algorithm makes use of a reinforced learning network.

8. The method of claim 1, wherein identifying the set of network functions further comprises using a network discovery algorithm.

9. The method of claim 8, wherein the network discovery algorithm is at least one of a genetic algorithm or a swarm-based algorithm.

10. The method of claim 8, wherein identifying the set of network functions comprises receiving messages transmitted by discovery agents.

11. The method of claim 1, wherein each network function within the set of network functions is made by one equipment vendor.

12. The method of claim 1, wherein a first network function within the set of network functions is made by an equipment vendor different from the equipment vendor associated with a second network function within the set of network functions.

13. The method of claim 12, wherein the first and second network functions are both compliant with the same standards.

14. The method of claim 1, wherein the network topology comprises a network service topology.

15. A method of connection admission into a network comprising:
receiving, from an application server outside the network, a request for admission of a connection between a node associated with the network and the application server;
determining, in accordance with an Artificial Intelligence or Machine Learning based model of the network, a path for the requested connection through user plane functions in the network;
transmitting to the application a connection admission reply in response to the received request and the determined path; and
transmitting to a node within the network a connection request determined in accordance with the received request and the determined path.

16. The method of claim 15 wherein the node associated with the network is connected to the network through a radio access network.

17. The method of claim 15 wherein the network is a core network associated with a mobile network.

18. The method of claim 15 wherein transmitting the connection request to the node within the network is performed after transmitting the connection admission reply/

19. The method of claim 15 further comprising receiving from the node within the network a reply to the admission request, and further wherein the step of transmitting a connection admission reply is performed before receiving the reply to the admission request from the node within the network.

20. A method of responding to a connection admission request from an application server, the method comprising:
determining, in accordance with an Artificial Intelligence or Machine Learning based model of the network, that a connection associated with the connection admission request cannot be supported by a network associated with the connection admission request without transmitting a request for admission to a node within the network;
transmitting to the application server a rejection of the connection admission request.

21. An application discovery function comprising a processor and a memory for storing instructions that when executed by the processor cause the application discovery function to carry out the method of claim 1.

22. The method of claim 1, further comprising, modifying at least one of configuration parameters or session parameters of the network topology.

23. The method of claim 1, further comprising, interacting with at least one of a management plane or a control plane of the network to influence or control at least one of a data plane or a transport plane of the network topology.

24. The method of claim 23, wherein the control comprises modifying a configuration of at least one of the data plane or the transport plane of the network topology.

25. The method of claim 1, further comprising, undertaking a network discovery process without relying on operator pre-configuration.

26. The method of claim 1, further comprising, excluding a certain type of network function from the network topology if such network function is excluded from access to external applications by the network operator.

27. The method of claim 1, further comprising, determining a service provided by each network function.

28. The method of claim 1, further comprising, determining a service provided by combinations of different network functions.

29. The method of claim 1, further comprising, transmitting the responses received from both the first subset of the identified set of network functions and the second subset of the identified set of network functions to at least one of an artificial intelligence or machine learning prediction engine.

30. The method of claim 29, wherein the at least one of an artificial intelligence or machine learning prediction engine uses the input to provide a prediction of the features supported by at least one of the network functions.

31. The method of claim 1, wherein the first request and the second request are interrogation based requests, and further comprising, reducing a number of interrogation based requests and a number of replies to process using a predictive engine.
